(19) United States
(12) Patent Application Publication
(10) Pub. No.: US 2019/0159958 A1
(43) Pub. Date: May 30, 2019

(54) Massaging Device with Heating Properties

(71) Applicant: Bradford Joseph Reycroft, Norfolk, MA (US)

(72) Inventor: Bradford Joseph Reycroft, Norfolk, MA (US)

(21) Appl. No.: 16/203,401

(22) Filed: Nov. 28, 2018

Related U.S. Application Data
(60) Provisional application No. 62/591,304, filed on Nov. 28, 2017.

(51) Int. Cl. A61H 15/02

(52) U.S. Cl. CPC A61H 15/02; A61H 2015/0064

(57) ABSTRACT

A massaging apparatus with heating capabilities includes a structural body, an internal chamber, a power source, a control switch, a control panel, and a heating unit. The structural body, which is preferably spherical in shape, is used for massaging purposes. The power source, the control switch, and the control panel, which are positioned within the internal chamber, are used to manage the heating unit that administers heat therapy. To do so, the heating unit is in thermal communication with an outer surface of the structural body. Thus, heat therapy can be provided to a target muscle by positioning the structural body against the skin of a user. Additionally, vibration therapy can also be administered via a vibrating unit.

The current application claims a priority to the U.S. Provisional Patent application Ser. No. 62/591,304 filed on Nov. 28, 2017.

### FIELD OF THE INVENTION

The present invention relates generally to an exercise device. More specifically, the present invention is a heated massaging device that can be used by athletes to address soft tissue damage and discomfort. The present invention includes a heating mechanism that further enhances the user's ability to target and repair injured or knotted tissue, as well as an optional vibrating feature and lead wire holes that allow the present invention to be utilized as a power source for electrical suction cup stimulation processes, known in the industry as transcutaneous electrical nerve stimulation (TENS) units.

### BACKGROUND OF THE INVENTION

Technology and resources for athletes both professional and amateur are improving competition across the spectrum of athletic activities. Among the more recent movements in athletic culture is the practice of targeted mobility exercises. As opposed to static stretching, mobility exercises and devices can be used to properly prepare muscles for activity and can thus prevent injury and improve performance if executed properly. While these exercises and several devices with similar soft-tissue targeting functions have been known for many decades, only recently are these devices and methods achieving the attention they deserve.

However, among the growing pains for incorporating these devices into mainstream usage are an abundance of required devices. Bands of various elasticities, balls of various sizes, platforms of different heights, rollers, and more are all part of the tools that can help a user address stiff or sore muscles before and after exercise. In addition, adding mechanisms like heat, vibration, and electrical stimulation also improve the ability of tools and external stimuli to target specific muscular areas for therapeutic attention. All of these tools, however, can take up a large amount of space in a bag or gym locker. What is needed is a means of combining several of these tools into one compact unit. Further needed is a device that enables the use of multiple stimulating mechanisms at the same time.

The present invention addresses these issues. The heated massage ball is a spherical device made of hard rubber or plastic that the user can press into various knots or muscles to relieve soft tissue distress, similar to how many balls and rollers are currently utilized by athletes. The present invention further utilizes a heating unit to provide warmth that increases blood flow in targeted areas, as well as, in several embodiments, vibrational stimulation. A remote enables a user to activate these functions after placing the present invention against a target area, as opposed to before. A pair of lead holes in the control panel area enable the user to insert a pair of leads into the Heated Massage Ball, thus utilizing the electrical charge stored within to power the electrical stimulation cups of tens units.

### BRIEF DESCRIPTION OF THE DRAWINGS

FIG. 1 is a perspective view of the present invention, wherein the chamber cover is in a closed configuration.

FIG. 2 is a perspective view of the present invention, wherein the chamber cover is in an open configuration.

FIG. 3 is a side view of the present invention.

FIG. 4 is a top view of the present invention.

FIG. 5 is a block diagram illustrating the electronic connections within the present invention and the connectivity to the wireless controller.

### DETAIL DESCRIPTIONS OF THE INVENTION

All illustrations of the drawings are for the purpose of describing selected versions of the present invention and are not intended to limit the scope of the present invention.

The present invention introduces a massaging device with heating properties. With the present invention, the user can effectively treat sore muscles and address injuries. The heating properties of the present invention improves circulation and blood flow to a preferred area. On the other hand, the massaging properties of the present invention helps release knots in a specific area of the body.

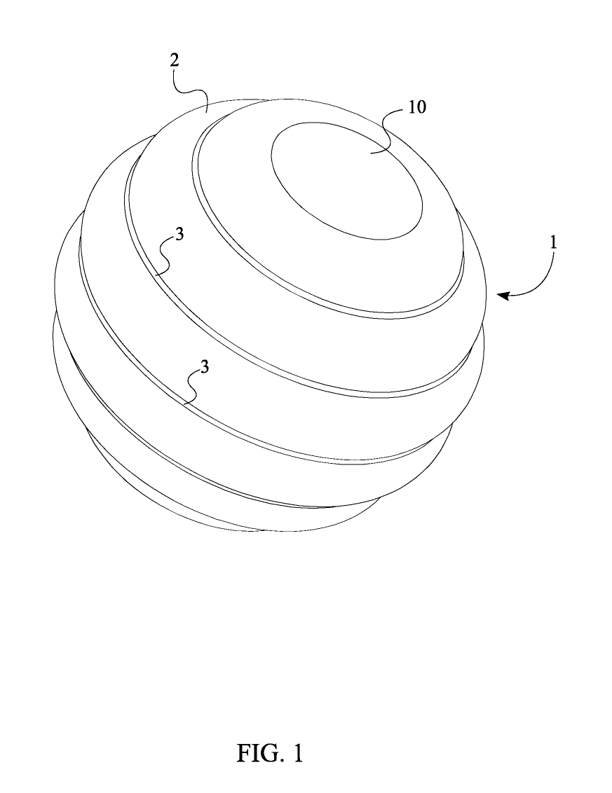

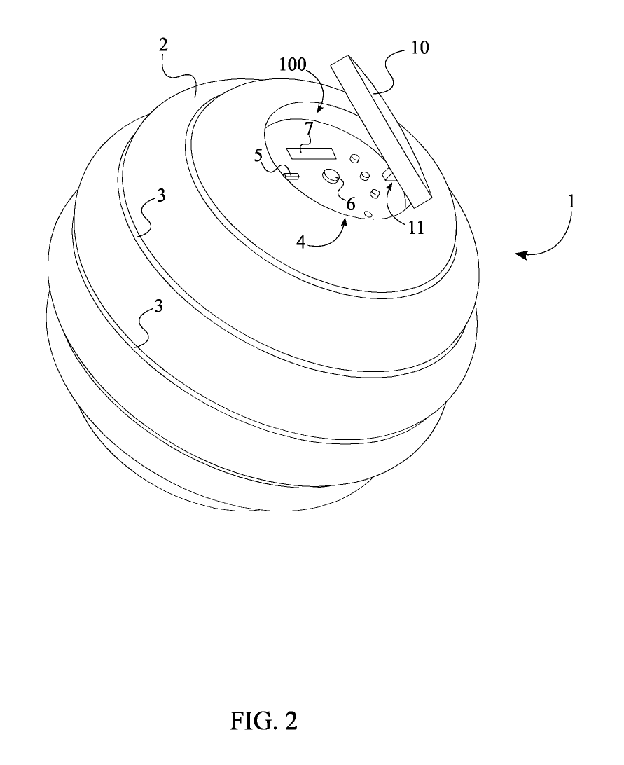

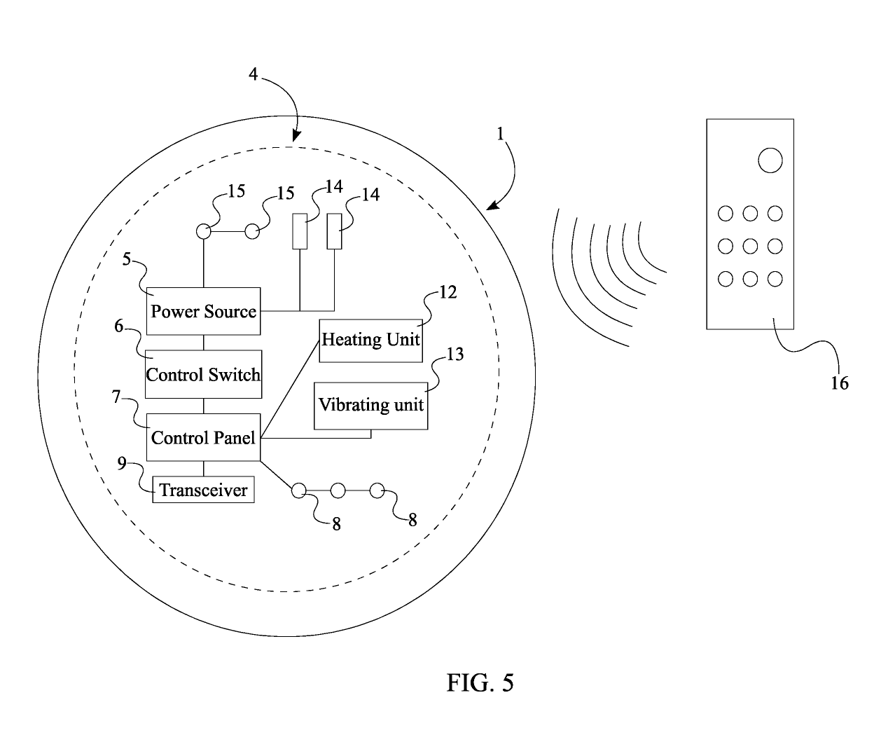

As illustrated in FIG. 1, FIG. 2, and FIG. 5, to fulfill the intended functionalities, the present invention comprises a structural body 1, an internal chamber 4, a power source 5, a control switch 6, a control panel 7, and a heating unit 12. The structural body 1 provides the overall shape and the weight required for massaging purposes. In the preferred embodiment of the present invention, the structural body 1 is spherical in shape. However, in other embodiments of the present invention, the structural body 1 can have a cylindrical or other functional shape. The overall weight and the materialistic properties of the structural body 1 can vary from one embodiment to another so that the overall feel of the structural body 1 is different. As an example, in one embodiment the structural body 1 can be manufactured of a lower density rubber. In another embodiment, the structural body 1 can be manufactured of a higher density rubber. The internal chamber 4 is used to hold the electronic components of the present invention. To maintain the overall shape of the structural body 1 while housing the electronic components, the internal chamber 4 traverses into the structural body 1. The power source 5, the control switch 6, and the control panel 7 are positioned within the internal chamber 4 so that the overall spherical shape of the preferred embodiment is maintained. The power source 5 is used to provide the electrical power to the heating unit 12 which is positioned within the structural body 1. The control switch 6 controls a current flow from the power source 5 to the heating unit 12. The control panel 7 is used to control the intensity of the heat emitted by the heating unit 12. To manage the current flow from the power source 5 to the heating unit 12, the power source 5 is electrically connected to the control panel 7 through the control switch 6. To control the heat emitted from the heating unit 12, the control panel 7 is electronically connected to the heating unit 12 which is in thermal communication with an outer surface 2 of the structural body 1. The heating unit 12 converts electrical power into heat, which is used to improve blood flow and enhance treatment ability for sore muscles or fascia. When in use, the outer surface 2 is in contact with the skin of the user and heat is transferred onto the skin of the user through the outer surface 2.

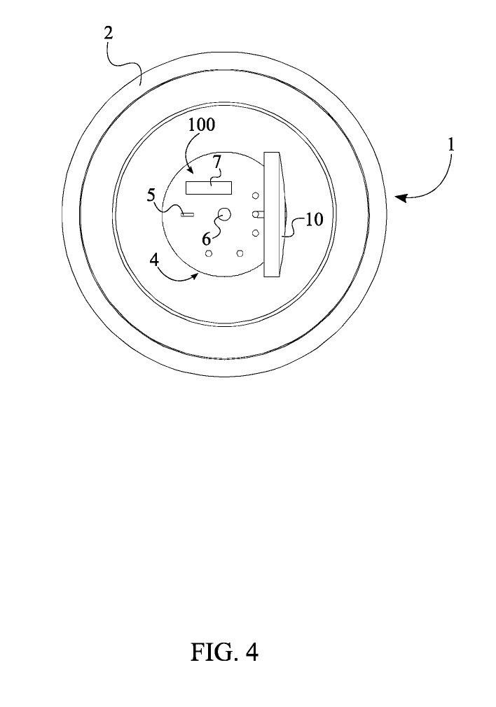

As seen in FIG. 2 and FIG. 4, the internal chamber 4 traverses into the structural body 1. Thus, an opening 100 of the internal chamber 4 which provides access to the power source 5, the control switch 6, and the control panel 7, occupies a surface area along the outer surface 2. Thus, the surface area available for massaging is reduced. To maximize the surface area available for massaging and to protect the electronic components, the present invention further comprises a chamber cover 10 that conceals the opening 100. The chamber cover 10 is hingedly connected to the structural body 1 through a hinging mechanism 11 so that the internal chamber 4 can be conveniently accessed when needed. In the resulting position, the chamber cover 10 is positioned over the opening 100. The chamber cover 10 is designed to be consistent with the opening 100 of the internal chamber 4. As an example, if the opening 100 is circular in shape, the chamber cover 10 will also be circular in shape.

As illustrated in FIG. 5, the present invention further comprises a plurality of indicators 8 that notify the user regarding functions that can be, but is not limited to, heat level emitted by the heating unit 12 and power level of the power source 5. For instance, a first indicator from the plurality of indicators 8 can be illuminated when the heating unit 12 emits a minimal amount of heat. Moreover, a second indicator from the plurality of indicators 8 can be illuminated if the heating unit 12 emits a maximum amount of heat. The plurality of indicators 8 is positioned within the internal chamber 4 and the control panel 7 is electronically connected to each of the plurality of indicators 8. The electronic connection between the control panel 7 and the plurality of indicators 8 allows the plurality of indicators 8 to illuminate according to the selections made by the user at the control panel 7.

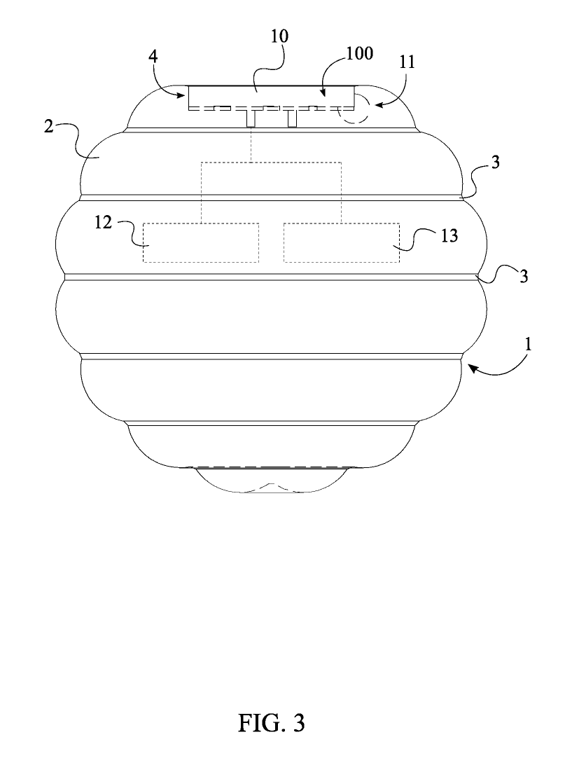

As shown in FIG. 3 and FIG. 5, in addition to using heat to treat muscle-related issues, the present invention can also use vibration therapy in another embodiment of the present invention. To do so, in another embodiment, the present invention comprises a vibrating unit 13 that will be positioned within the structural body 1. Like the heating unit 12, the vibrating unit 13 will also be electronically connected to the control panel 7 so that the vibrations of the vibrating unit 13 can be managed by the control panel 7. Since the control panel 7 is electrically connected to the power source 5, the vibrating unit 13 draws the required electrical power from the power source 5. The electronic connection between the control panel 7 and the vibrating unit 13 allows the user to control the intensity of the vibrations generated by the vibrating unit 13. To transfer the vibrating motion onto the skin of the user, the vibrating unit 13 is in vibrational communication with the outer surface 2 of the structural body 1.

The power source 5 used to provide the necessary electric power can vary from one embodiment to another. In the preferred embodiment of the present invention, the power source 5 is a rechargeable battery. However, the power source 5 can vary in different embodiments of the present invention. As seen in FIG. 5, to charge the rechargeable battery, the present invention further comprises at least one input/output port 14 that is positioned within the internal chamber 4. The positioning of the at least one input/output port 14 ensures that the outer surface 2 of the structural body 1 is entirely available for massaging purposes. To recharge the power source 5 as necessary, the at least one input/output port 14 is electrically connected to the power source 5. In another embodiment, if the present invention utilizes a processing unit along with the control panel 7, the at least one input/output port 14 can be used to access the processing unit. In such instances, the at least one input/output port 14 will be electronically connected to the control panel 7.

The present invention can also be configured to transmit electrical currents to targeted body parts to execute transcutaneous electric nerve stimulation. As illustrated in FIG. 5, to administer the process, the present invention comprises at least one pair of stimulation sockets 15 that is positioned within the internal chamber 4. The at least one pair of stimulation sockets 15 is electronically connected to the control panel 7 which is also electrically connected to the power source 5. Thus, by connecting a pair of external electrode pads to the at least one pair of stimulation sockets 15, current can be drawn from the power source 5. The overall frequency of the current drawn from the power source 5 is controlled through the control panel 7.

For user convenience, the present invention is equipped with the ability to be remotely controlled. As shown in FIG. 5, to do so, the present invention further comprises a wireless controller 16 and a transceiver 9. The wireless controller 16 is used to transmit the user commands to the control panel 7. The transceiver 9, which is positioned within the internal chamber 4, is used to receive the user commands transmitted from the wireless controller 16. To receive the user commands from the wireless controller 16, the transceiver 9 is communicably coupled with the transceiver 9. When user commands are received at the transceiver 9, the user commands are transferred onto the control panel 7 so that the heating unit 12 or the vibrating unit 13 can be appropriately activated. To do so, the transceiver 9 is electronically connected to the control panel 7. The line of communication established between the wireless controller 16, transceiver 9, and the control panel 7 allows the user to remotely control the heating or vibration applied onto the skin through the outer surface 2 of the structural body 1.

When executing a massage process with the present invention, the user may need to provide specific, targeted pressure to more sensitive, smaller targeted areas. As seen in FIGS. 1-3, to fulfill the need, the present invention comprises a plurality of ridges 3 that is positioned along the outer surface 2 of the structural body 1. In the preferred embodiment, wherein the structural body 1 is spherical in shape, each of the plurality of ridges 3 is positioned in parallel to a horizontal axis of the sphere. However, in other embodiments of the present invention, the plurality of ridges 3 can be positioned differently.

When the present invention is being used, the following process flow is generally followed. If the user intends on using the present invention solely for massaging, the present invention is placed at the target muscle. When the outer surface 2 of the structural body 1 is in contact with the skin, the user proceeds to execute a rolling motion so that the target muscle is stimulated and relaxed. If the user intends on utilizing heat to treat the target muscle, the present invention is placed at the target muscle and the heating unit 12 is activated via the control switch 6 and the control panel 7. In another instance, if the user intends on using vibration therapy, the vibrating unit 13 is activated via the control switch 6 and the control panel 7. In another instance, if the user intends on utilizing electric pulses on the target muscle, a pair of external electrode pads is connected to the at least one pair of stimulation sockets 15. The electric currents transferred onto the skin are controlled via the control panel 7.

Although the invention has been explained in relation to its preferred embodiment, it is to be understood that many other possible modifications and variations can be made without departing from the spirit and scope of the invention as hereinafter claimed.

What is claimed is:

1. A massaging device with heating properties comprises:
a structural body;
an internal chamber;
a power source;
a control switch;
a control panel;
a heating unit;
the internal chamber traversing into the structural body;
the power source, the control switch, and the control panel being positioned within the internal chamber;
the power source being electrically connected to the control panel through the control switch;
the control panel being electronically connected to the heating unit;
the heating unit being positioned within the structural body; and
the heating unit being in thermal communication with an outer surface of the structural body.

2. The massaging device with heating properties as claimed in claim 1, wherein the structural body is spherical in shape.

3. The massaging device with heating properties as claimed in claim 1 further comprises:
a chamber cover;
a hinging mechanism;
the internal chamber comprises an opening; and
the chamber cover being hingedly connected to the structural body over the opening through the hinging mechanism.

4. The massaging device with heating properties as claimed in claim 1 further comprises:
a plurality of indicators;
the plurality of indicators being positioned within the internal chamber; and
the control panel being electronically connected to each of the plurality of indicators.

5. The massaging device with heating properties as claimed in claim 1 further comprises:
a vibrating unit;
the vibrating unit being positioned within the structural body;
the control panel being electronically connected to the vibrating unit; and
the vibrating unit being in vibrational communication with the outer surface of the structural body.

6. The massaging device with heating properties as claimed in claim 1 further comprises:
at least one input/output port;
the at least one input/output port being positioned within the internal chamber; and
the at least one input/output port being electrically connected to the power source.

7. The massaging device with heating properties as claimed in claim 1 further comprises:
at least one pair of stimulation sockets;
the at least one pair of stimulation sockets being positioned within the internal chamber; and
the at least one pair of stimulation sockets being electronically connected to the control panel.

8. The massaging device with heating properties as claimed in claim 1 further comprises:
a wireless controller;
a transceiver;
the transceiver being positioned within the internal chamber;
the transceiver being electronically connected to the control panel; and
the wireless controller being communicably coupled with the transceiver.

9. The massaging device with heating properties as claimed in claim 1 further comprises:
a plurality of ridges; and
the plurality of ridges being positioned along the outer surface of the structural body.

10. A massaging device with heating properties comprises:
a structural body;
an internal chamber;
a power source;
a control switch;
a control panel;
a heating unit;
a vibrating unit;
the internal chamber traversing into the structural body;
the power source, the control switch, and the control panel being positioned within the internal chamber;
the power source being electrically connected to the control panel through the control switch;
the control panel being electronically connected to the heating unit;
the heating unit being positioned within the structural body;
the heating unit being in thermal communication with an outer surface of the structural body;
the vibrating unit being positioned within the structural body;
the control panel being electronically connected to the vibrating unit; and
the vibrating unit being in vibrational communication with the outer surface of the structural body.

11. The massaging device with heating properties as claimed in claim 10, wherein the structural body is spherical in shape.

12. The massaging device with heating properties as claimed in claim 10 further comprises:
a chamber cover;
a hinging mechanism;
the internal chamber comprises an opening; and
the chamber cover being hingedly connected to the structural body over the opening through the hinging mechanism.

13. The massaging device with heating properties as claimed in claim 10 further comprises:
a plurality of indicators;
the plurality of indicators being positioned within the internal chamber; and
the control panel being electronically connected to each of the plurality of indicators.

14. The massaging device with heating properties as claimed in claim 10 further comprises:
at least one input/output port;
the at least one input/output port being positioned within the internal chamber; and
the at least one input/output port being electrically connected to the power source.

15. The massaging device with heating properties as claimed in claim 10 further comprises:
at least one pair of stimulation sockets;
the at least one pair of stimulation sockets being positioned within the internal chamber; and
the at least one pair of stimulation sockets being electronically connected to the control panel.

16. The massaging device with heating properties as claimed in claim 10 further comprises:
a wireless controller;
a transceiver;
the transceiver being positioned within the internal chamber;
the transceiver being electronically connected to the control panel; and
the wireless controller being communicably coupled with the transceiver.

17. The massaging device with heating properties as claimed in claim 10 further comprises:
a plurality of ridges; and
the plurality of ridges being positioned along the outer surface of the structural body.
